(19) United States
(12) Patent Application Publication
(10) Pub. No.: US 2025/0283753 A1
(43) Pub. Date: Sep. 11, 2025

(54) Portable Scale Device

(71) Applicant: Veton Krasniqi, Brooklyn, NY (US)

(72) Inventor: Veton Krasniqi, Brooklyn, NY (US)

(21) Appl. No.: 18/601,753

(22) Filed: Mar. 11, 2024

(51) Int. Cl. G01G 21/22

(52) U.S. Cl. CPC G01G 21/22

(57) ABSTRACT

A portable scale device for weighing and transporting materials while inhibiting the materials from physically contacting the scale includes a scale including a weighing platform and a processor. A weight sensor is electrically coupled to the processor to measure a weight of a material positioned on the weighing platform. A display panel is electrically coupled to the processor to display the weight of the material. A container is releasably couplable to the scale to hold the material while the weight sensor is measuring the weight of the material. The container includes a base that is positioned over the weighing platform to inhibit the material from physically contacting the scale. A sleeve is releasably couplable to the base. A lid is releasably couplable to the sleeve and is designed to inhibit access to the material that is held within the container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to scales and more particularly pertains to a new scale for weighing and transporting materials while inhibiting the materials from physically contacting the scale.

### (2) Description of Related Art Including Information Disclosed Under 37 CFR 1.97 and 1.98

The prior art relates to scales. Scales are used in a wide array of situations, for weighing various items and materials. For example, digital pocket scales provide portability and are often used to measure ingredients for meals. However, such scales often include sensitive electronic equipment that can be damaged by debris from the ingredients or other materials being weighed. Additionally, the ingredients or materials themselves are often lightweight, making it easy for the materials to fall off of the scale. Finally, although pocket scales themselves are portable, people need to remove the weighed material from the scale and put the weighed material in a secondary container if the weighed material needs to be transported to a secondary location. Thus, there is a need in the art for a pocket scale with a container that can hold the material being weighed, to protect the components of the scale and to facilitate transport of the material.

### BRIEF SUMMARY OF THE INVENTION

An embodiment of the disclosure meets the needs presented above by generally comprising a scale including a weighing platform and a processor that is operationally coupled to the weighing platform. A weight sensor is electrically coupled to the processor wherein the weight sensor is configured to measure a weight of a material that is positioned on the weighing platform. A display panel is electrically coupled to the processor wherein the display panel is configured to display the weight of the material being measured by the weight sensor. A container is releasably couplable to the scale. The container is configured to hold the material while the weight sensor is measuring the weight of the material. The container includes a base that is positioned over the weighing platform when the base is coupled to the scale wherein the base is configured to inhibit the material from physically contacting the scale while the weight sensor is measuring the weight of the material. A sleeve is releasably couplable to the base. The sleeve has an upper end and a lower end. Each of the upper end and the lower end is open wherein the upper end and the lower end are each configured to facilitate placement of the material within the container. A lid is releasably couplable to the sleeve. The lid is positionable over the upper end of the sleeve wherein the lid is configured to inhibit access to the material being held within the container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a portable scale device according to an embodiment of the disclosure.

FIG. 2 is a bottom isometric view of an embodiment of the disclosure.

FIG. 3 is a detail bottom isometric view of an embodiment of the disclosure.

FIG. 4 is a detail bottom isometric view of an embodiment of the disclosure.

FIG. 5 is a detail side view of an embodiment of the disclosure.

FIG. 6 is an in-use view of an embodiment of the disclosure.

FIG. 7 is a detail view of an embodiment of the disclosure.

FIG. 8 is a detail view of an embodiment of the disclosure.

FIG. 9 is an isometric view of an embodiment of the disclosure.

FIG. 10 is an isometric view of an embodiment of the disclosure.

FIG. 11 is an isometric view of an embodiment of the disclosure.

FIG. 12 is a block diagram view of an embodiment of the disclosure.

### DETAILED DESCRIPTION OF THE INVENTION

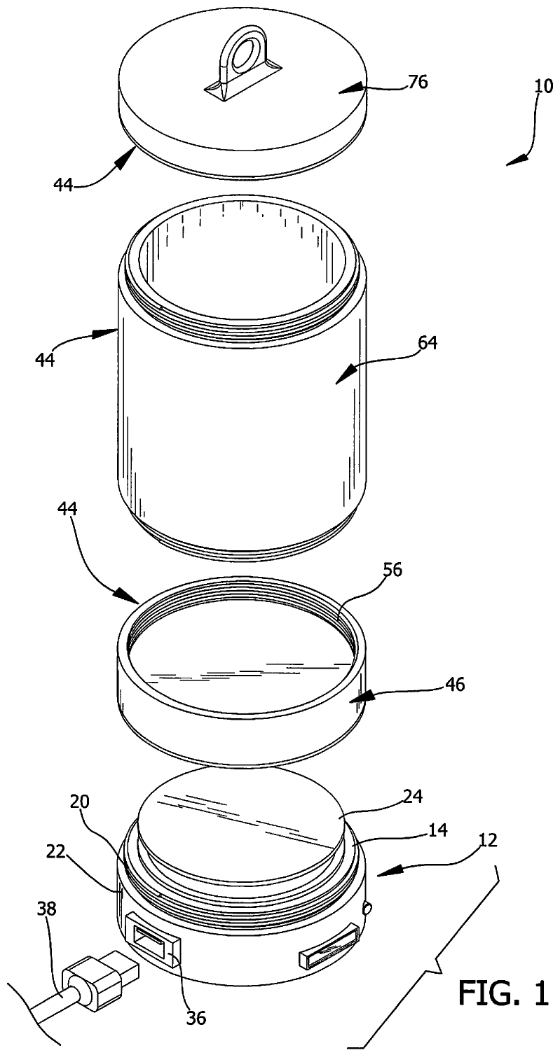

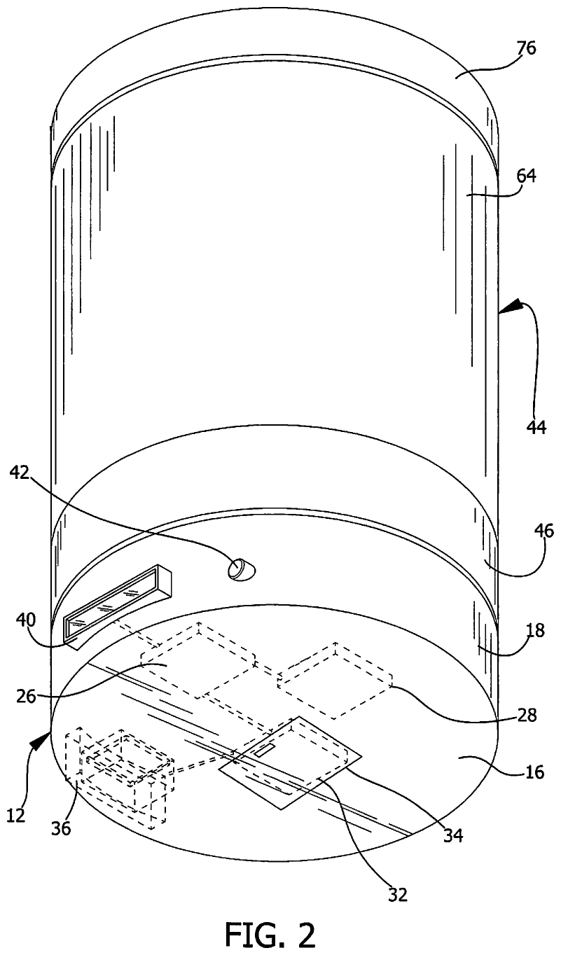

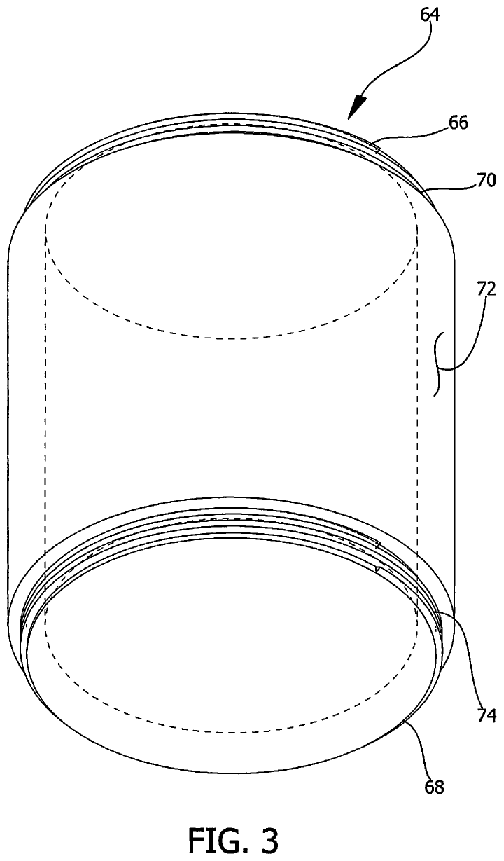

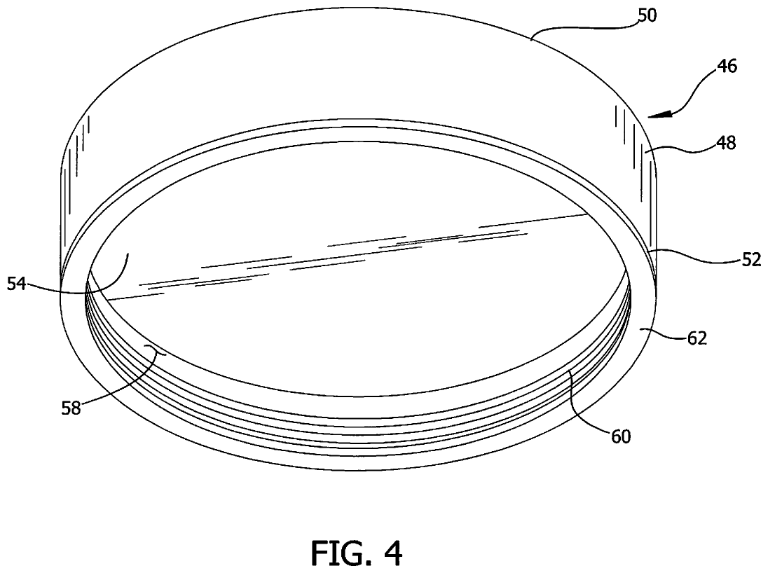

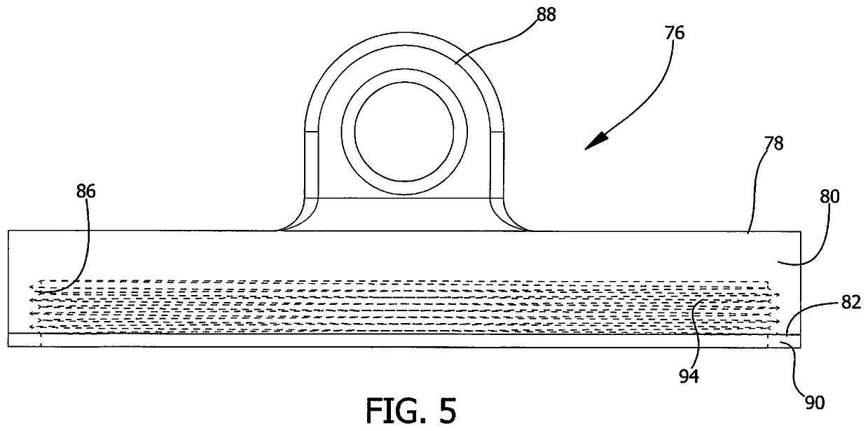

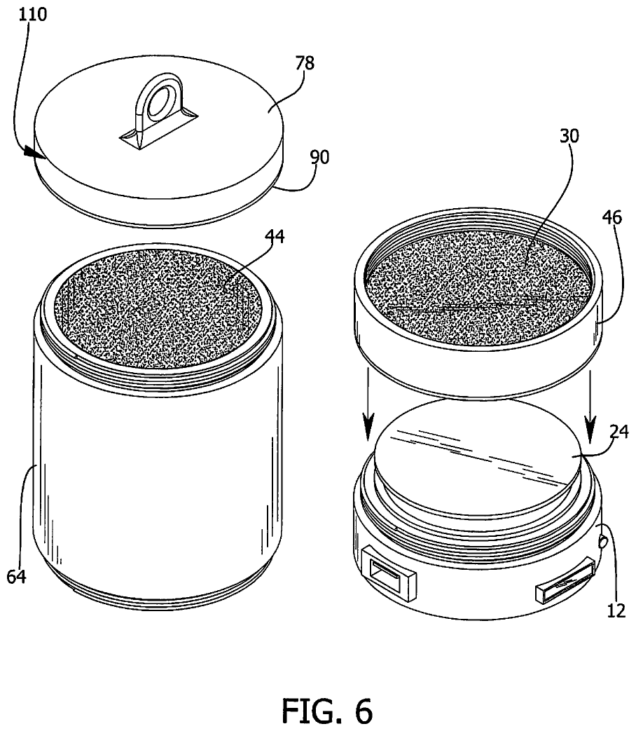

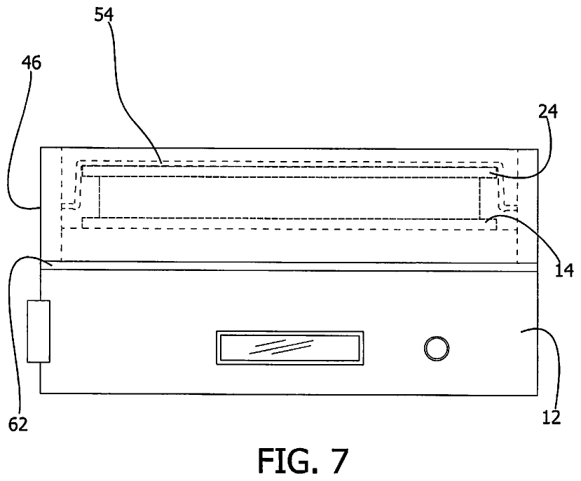

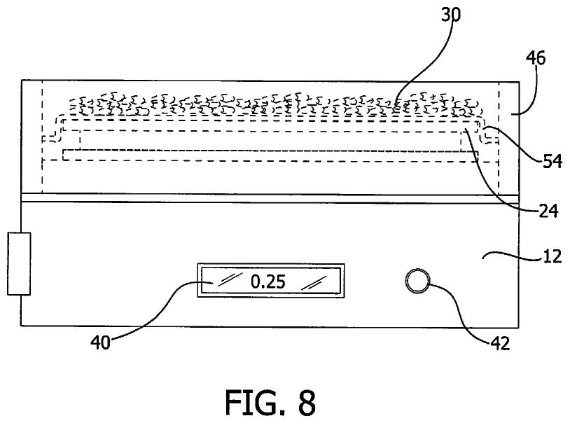

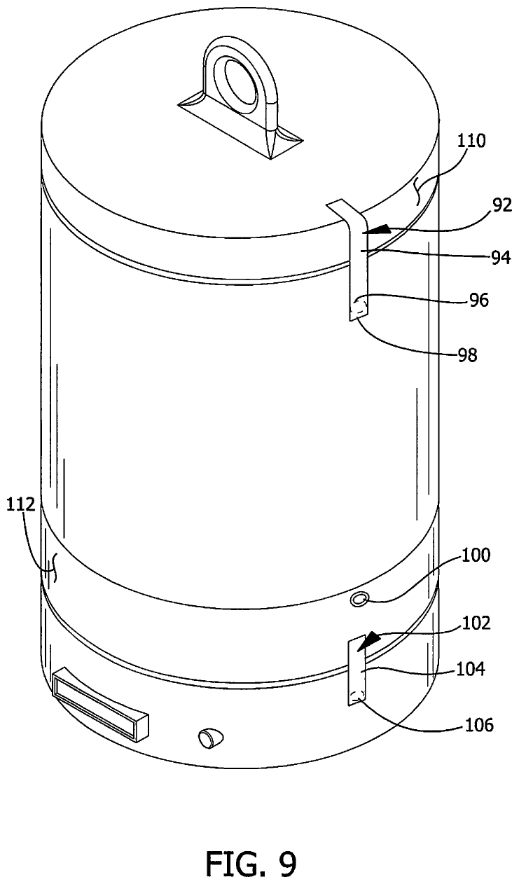

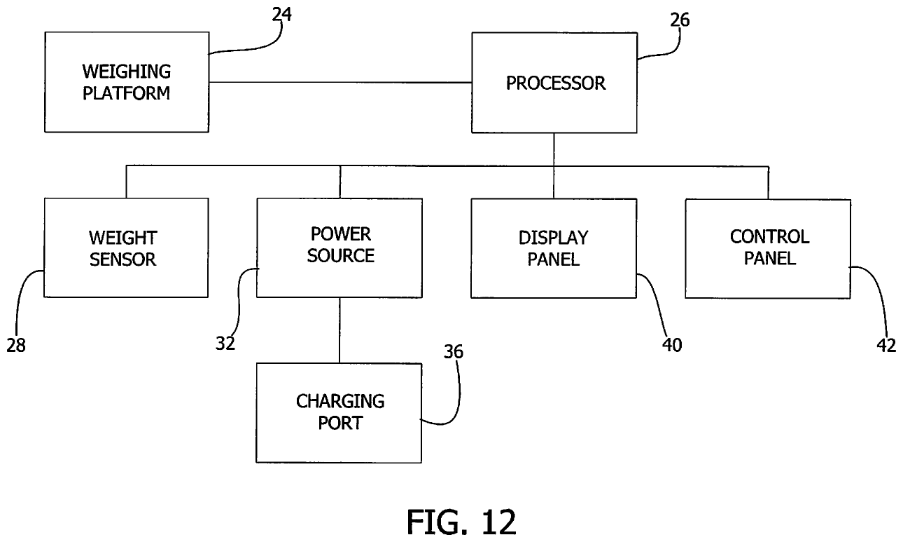

With reference now to the drawings, and in particular to FIGS. 1 through 12 thereof, a new scale embodying the principles and concepts of an embodiment of the disclosure and generally designated by the reference numeral 10 will be described.

As best illustrated in FIGS. 1 through 12, the portable scale device 10 generally comprises a scale 12. For example, the scale 12 may have a top panel 14, a bottom panel 16, and a side panel 18 that is coupled to and extends between the top panel 14 and the bottom panel 16. Generally, the bottom panel 16 is planar so that the scale 12 can stably rest on a surface to measure a weight of an item. The side panel 18 may have a threaded upper portion 20 extending downwardly from the top panel 14. The threaded upper portion 20 is generally positioned on an outer surface 22 of the scale 12.

The scale 12 may further comprise a weighing platform 24. For example, the weighing platform 24 may be coupled to the top panel 14. The weighing platform 24 may be planar. The weighing platform 24 may extend upwardly from the top panel 14. The weighing platform 24 may be movably coupled to the top panel 14 wherein a position of the weighing platform 24 is vertically adjustable relative to the top panel 14.

A processor 26 may be positioned inside the scale 12. The processor 26 is operationally coupled to the weighing platform 24.

A weight sensor 28 is electrically coupled to the processor 26 wherein the weight sensor 28 is configured to measure a weight of a material 30 that is positioned on the weighing platform 24. The weight sensor 28 is generally positioned inside of the scale 12 and may be operationally coupled to the weighing platform 24.

A power source 32 may be electrically coupled to the processor 26. The power source 32 may include a battery, for example a rechargeable battery. The power source 32 may be positioned inside of the scale 12.

An access door 34 may be coupled to the scale 12. For example, the access door 34 may be positioned on the bottom panel 16 of the scale 12. The access door 34 may be movably or pivotably coupled to the bottom panel 16 and is generally aligned with the power source 32 wherein the access door 34 is openable to facilitate access to the power source 32.

A charging port 36 may be electrically coupled to the power source 32 wherein the charging port 36 is configured to receive a charging cable 38 for recharging the power source 32. The charging port 36 may be inset into the side panel 18 of the scale 12 and exposed within the side panel 18 of the scale 12, for example to facilitate use of the scale while the power source 32 is being recharged. Alternatively, the charging port 36 may be positioned on the bottom panel 16 of the scale 12.

A display panel 40 is electrically coupled to the processor 26 wherein the display panel 40 is configured to display the weight of the material 30 that is measured by the weight sensor 28. For example, the display panel 40 is coupled to the side panel 18 of the scale 12.

A control panel 42 may be electrically coupled to the processor 26 wherein the processor 26 is configured to actuate the weight sensor 28 when the control panel 42 is manipulated. The processor 26 may also be configured to tare the weight sensor 28 when the control panel 42 is manipulated. The control panel 42 may be coupled to the side panel 18 of the scale 12, for example adjacent to the display panel 40. In some embodiments, the control panel 42 comprises a button.

A container 44 is releasably couplable to the scale 12. The container 44 is configured to hold the material 30 while the weight sensor 28 is measuring the weight of the material 30, such that the material 30 does not need to be placed directly on the scale 12. The container 44 therefore helps to keep the scale 12 clean, inhibiting the material 30 from clogging or damaging components of the scale 12. The container 44 can also be used to transport the material 30 once the material 30 has been weighed. For example, the container 44 can be removed from the scale 12 to transport the material 30, or the container 44 can remain attached to the scale 12 for simultaneous transport of the scale 12, the container 44, and the material 30.

The container 44 generally includes a base 46 that is releasably couplable to the scale 12. The base 46 is generally positioned over the weighing platform 24 when the base 46 is coupled to the scale 12 wherein the base 46 is configured to inhibit the material 30 from physically contacting the scale 12, for example while the weight sensor 28 is measuring the weight of the material 30.

The base 46 may further comprise a peripheral wall 48 that has a top edge 50 and a bottom edge 52. The peripheral wall 48 extends upwardly from the scale 12 when the base 46 is coupled to the scale 12 wherein the bottom edge 52 is positioned proximate to the scale 12 and the top edge 50 is positioned above the scale 12.

A central wall 54 may be coupled to the peripheral wall 48. The central wall 54 is generally spaced from both the top edge 50 and the bottom edge 52 of the peripheral wall 48 wherein the central wall 54 is positionable on top of the weighing platform 24 when the base 46 is coupled to the scale 12 and wherein the base 46 is configured to hold the material 30 on top of the central wall 54. The central wall 54 is in physical contact with the weighing platform 24 of the scale 12 wherein the weight sensor 28 is configured to measure the weight of the material 30 that is positioned on top of the central wall 54 when the base 46 is coupled to the scale 12. For example, the central wall 54 may comprise a flexible material wherein the weighing platform 24 is configured to exert upward pressure on the central wall 54 when the base 46 is coupled to the scale 12 and wherein the central wall 54 is configured to exert a downward pressure on the weighing platform 24 when the material 30 is positioned on top of the central wall 54. The weight sensor 28 is configured to measure the weight of the material 30 based on the downward pressure that is exerted on the weighing platform 24 by the central wall 54 and the material 30. For example, the flexible material of the central wall 54 may include rubber or silicone. The central wall 54 is generally coextensive with the weighing platform 24 wherein the base 46 is configured to inhibit the material 30 from physically contacting the weighing platform 24 of the scale 12 when the base 46 is coupled to the scale 12.

A top threading 56 may extend downwardly from the top edge 50 of the peripheral wall 48 of the base 46 toward the central wall 54. The top threading 56 may be positioned on an interior surface 58 of the base 46.

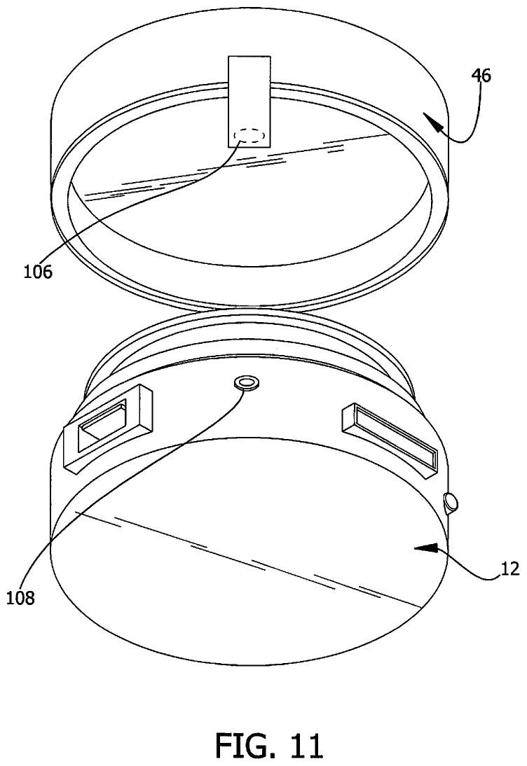

A bottom threading 60 may extend upwardly from the bottom edge 52 of the peripheral wall 48 of the base 46 toward the central wall 54. The bottom threading 60 may be positioned on the interior surface 58 of the base 46. The bottom threading 60 is complementary to the threaded upper portion 20 of the side panel 18 of the scale 12 wherein the base 46 is threadably couplable to the scale 12. In alternative embodiments, the base 46 may snap onto the scale 12 for a friction fit rather than a threaded coupling, for example as shown in FIG. 11.

A base gasket 62 may be coupled to the base 46. The base gasket 62 is generally positioned on the bottom edge 52 of the peripheral wall 48. The base gasket 62 may be coextensive with the bottom edge 52 of the peripheral wall 48. The base gasket 62 may comprise a rubber material 30 wherein the base gasket 62 is configured to seal a junction between the base 46 and the scale 12 when the base 46 is coupled to the scale 12 whereby the base gasket 62 is configured to inhibit airflow into the container 44.

A sleeve 64 is releasably couplable to the base 46. The sleeve 64 generally includes an upper end 66 and a lower end 68. Each of the upper end 66 and the lower end 68 is typically open wherein the upper end 66 and the lower end 68 are each configured to facilitate placement of the material 30 within the container 44. The sleeve 64 may extend upwardly from the base 46 when the sleeve 64 is coupled to the base 46 wherein the sleeve 64 is configured to increase an amount of the material 30 that can be held within the container 44. The sleeve 64 may have a height exceeding a height of the base 46.

The sleeve 64 may further include an upper end threading 70 that extends downwardly from the upper end 66. The upper end threading 70 may be positioned on an external surface 72 of the sleeve 64.

A lower end threading 74 may extend upwardly from the lower end 68 of the sleeve 64. The lower end threading 74 may be positioned on the external surface 72 of the sleeve 64. The lower end threading 74 may be spaced from the upper end threading 70. The lower end threading 74 is complementary to the top threading 56 on the peripheral wall 48 of the base 46 wherein the sleeve 64 is threadably couplable to the base 46. In alternative embodiments, the sleeve 64 may snap onto the base 46 for a friction fit rather than a threaded coupling.

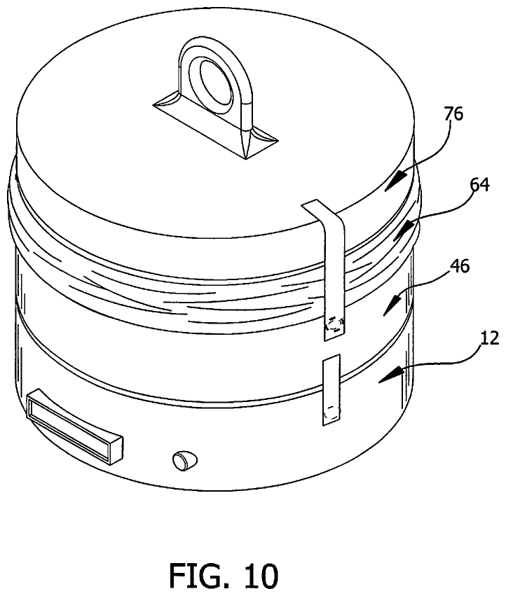

The sleeve 64 may include a resiliently compressible material extending between the upper end 66 and the lower end 68 wherein a height of the sleeve 64 is compressible to facilitate transportation and storage of the container 44, as shown in FIG. 10.

A lid 76 is releasably couplable to the sleeve 64. The lid 76 is positionable over the upper end 66 of the sleeve 64 wherein the lid 76 is configured to inhibit access to the material 30 that is held within the container 44.

For example, the lid 76 may include an upper plate 78 that may be parallel to the central wall 54 when the sleeve 64 is coupled to the base 46 and when the lid 76 is coupled to the sleeve 64. A lateral plate 80 may be coupled to and extend downwardly from the upper plate 78. The lateral plate 80 may have a terminal edge 82 that is spaced from the upper plate 78.

A lid threading 84 may extend upwardly from the terminal edge 82 of the lateral plate 80. The lid threading 84 may be positioned on an internal face 86 of the lateral plate 80. The lid threading 84 is complementary to the upper end threading 70 of the sleeve 64 wherein the lid 76 is threadably couplable to the sleeve 64. In alternative embodiments, the lid 76 may snap onto the sleeve 64 for a friction fit rather than a threaded coupling.

A handle 88 may be coupled to the upper plate 78. For example, the handle 88 may extend upwardly from the upper plate 78 wherein the handle 88 is configured to facilitate a user in gripping the lid 76.

A lid gasket 90 may be coupled to the lid 76. The lid gasket 90 is generally positioned on the terminal edge 82 of the lateral plate 80 of the lid 76. The lid gasket 90 may be coextensive with the terminal edge 82 of the lateral plate 80. The lid gasket 90 may comprise a rubber material wherein the lid gasket 90 is configured to seal a junction between the lid 76 and the sleeve 64 when the lid 76 is coupled to the sleeve 64 whereby the lid gasket 90 is configured to inhibit airflow into the container 44.

A lid retainer 92 may releasably couple the lid 76 to the base 46 when the sleeve 64 is compressed. For example, the lid retainer 92 may include a lid strap 94 that is coupled to the upper plate 78 of the lid 76. The lid strap 94 may extend downwardly from the upper plate 78 of the lid 76. A first retaining member 96 may be attached to the lid strap 94. The first retaining member 96 may be positioned proximate to a free end 98 of the lid strap 94. A second retaining member 100 may be releasably engageable with the first retaining member 96. The second retaining member 100 may be coupled to an exterior surface 112 of the peripheral wall 48 of the base 46. The second retaining member 100 is alignable with the first mating member when the sleeve 64 is compressed. In some embodiments, each of the first retaining member 96 and the second retaining member 100 comprise a snap. Alternatives for each of the first retaining member 96 and the second retaining member 100, such as a hook and loop material, a magnet, or a button and buttonhole, are also contemplated.

A base retainer 102 may releasably couple the base 46 to the scale 12. For example, the base retainer 102 may include a base strap 104 that is coupled to the peripheral wall 48 of the base 46. The base strap 104 may extend downwardly past the bottom edge 52 of the peripheral wall 48. A first fastening piece 106 may be attached to the base strap 104. A second fastening piece 108 may be releasably engageable with the first fastening piece 106. The second fastening piece 108 may be coupled to the side panel 18 of the scale 12. The second fastening piece 108 is alignable with the first fastening piece 106 when the base 46 is coupled to the scale 12. Each of the first fastening piece 106 and the second fastening piece 108 may comprise a snap. Alternatives for each of the first fastening piece 106 and the second fastening piece 108, such as a hook and loop material, a magnet, or a button and buttonhole, are also contemplated.

The outer surface 22 of the scale 12 may be coplanar with the exterior surface 112 of the base 46 when the base 46 is coupled to the scale 12. The exterior surface 112 of the base 46 may be coplanar with the external surface 72 of the sleeve 64 when the sleeve 64 is coupled to the base 46. The external surface 72 of the sleeve 64 may be coplanar with an external face 110 of the lid 76 when the lid 76 is coupled to the sleeve 64.

Each of the peripheral wall 48 of the base 46 and the lid 76 may comprise a rigid material that is configured to inhibit damage to the material 30 when the material 30 is held within the container 44 and when the sleeve 64 is compressed. For example, rigid materials may include plastic, wood, glass, or other natural or synthetic materials.

The figures show the scale 12 and container 44 are generally cylindrical, which facilitates threadably coupling each of the pieces together. In alternative embodiments, particularly those using a friction fit where the pieces snap together, the pieces may have alternative shapes.

In use, the container 44 may be coupled to the scale 12. For example, the base 46 may be coupled to the scale 12, or the base 46 and the sleeve 64 may be coupled together, then coupled to the scale 12. The material 30 may be positioned on top of the central wall 54 of the base 46. The material 30 then exerts a downward pressure on the central wall 54 and the weighing platform 24 of the scale 12 so that the weight sensor 28 can determine the weight of the material 30. The lid 76 may be coupled to the sleeve 64 to keep the material 30 safely enclosed within the container 44 during transport, either while the container 44 is coupled to the scale 12 or while the container 44 is decoupled from the scale 12. In some embodiments, the sleeve 64 may be compressed to reduce the size of the container 44 and facilitate transport.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A scale assembly comprising:
a scale comprising:
a weighing platform;
a processor being operationally coupled to the weighing platform;
a weight sensor being electrically coupled to the processor wherein the weight sensor is configured to measure a weight of a material being positioned on the weighing platform;
a display panel being electrically coupled to the processor wherein the display panel is configured to display the weight of the material being measured by the weight sensor;
a container being releasably couplable to the scale, the container being configured to hold the material while the weight sensor is measuring the weight of the material, the container comprising:
a base being positioned over the weighing platform when the base is coupled to the scale wherein the base is configured to inhibit the material from physically contacting the scale while the weight sensor is measuring the weight of the material;
a sleeve being releasably couplable to the base, the sleeve having an upper end and a lower end, each of the upper end and the lower end being open wherein the upper end and the lower end are each configured to facilitate placement of the material within the container; and
a lid being releasably couplable to the sleeve, the lid being positionable over the upper end of the sleeve wherein the lid is configured to inhibit access to the material being held within the container.

2. The scale assembly of claim 1, the base of the container further comprising:
a peripheral wall having a top edge and a bottom edge, the peripheral wall extending upwardly from the scale when the base is coupled to the scale wherein the bottom edge is positioned adjacent to scale and the top edge is positioned above the scale; and
a central wall being coupled to the peripheral wall, the central wall being spaced from the top edge and the bottom edge of the peripheral wall wherein the central wall is positionable on top of the weighing platform when the base is coupled to the scale and wherein the base is configured to hold the material on top of the central wall, the central wall being in physical contact with the weighing platform of the scale wherein the weight sensor is configured to measure the weight of the material being positioned on top of the central wall when the base is coupled to the scale, the central wall comprising a flexible material wherein the weighing platform is configured to exert upward pressure on the central wall when the base is coupled to the scale and wherein the central wall is configured to exert a downward pressure on the weighing platform when the material is positioned on top of the central wall, the weight sensor being configured to measure the weight of the material based on the downward pressure being exerted on the weighing platform by the central wall.

3. The scale assembly of claim 2, wherein the central wall is coextensive with the weighing platform wherein the base is configured to inhibit the material from physically contacting the weighing platform of the scale when the base is coupled to the scale.

4. The scale assembly of claim 2, the base of the container further comprising a top threading extending downwardly from the top edge of the peripheral wall of the base toward the central wall, the sleeve of the container further comprising a lower end threading extending upwardly from the lower end of the sleeve, the lower end threading being complementary to the top threading on the peripheral wall of the base wherein the sleeve is threadably couplable to the base.

5. The scale assembly of claim 2, further comprising:
a threaded upper portion extending downwardly from a top panel of the scale; and
a bottom threading extending upwardly from the bottom edge of the peripheral wall of the base toward the central wall, the bottom threading being complementary to the threaded upper portion of the side panel of the scale wherein the base is threadably couplable to the scale.

6. The scale assembly of claim 1, further comprising a base gasket being coupled to the base, the base gasket comprising a rubber material wherein the base gasket is configured to seal a junction between the base and the scale when the base is coupled to the scale whereby the base gasket is configured to inhibit airflow into the container when the base is coupled to the scale.

7. The scale assembly of claim 1, the sleeve further comprising a resiliently compressible material extending between the upper end and the lower end wherein a height of the sleeve is compressible to facilitate transportation and storage of the container.

8. The scale assembly of claim 7, further comprising a lid retainer releasably coupling the lid to the base when the sleeve is compressed, the lid retainer including:
a lid strap being coupled to the lid;
a first retaining member being attached to the lid strap; and
a second retaining member being releasably engageable with the first retaining member, the second retaining member being coupled to the base, the second retaining member being alignable with the first mating member when the sleeve is compressed.

9. The scale assembly of claim 1, the sleeve further comprising an upper end threading extending downwardly from the upper end.

10. The scale assembly of claim 9, the lid further comprising:
an upper plate being parallel to the central wall of the base when the sleeve is coupled to the base and when the lid is coupled to the sleeve;
a lateral plate being coupled to and extending downwardly from the upper plate, the lateral plate having a terminal edge being spaced from the upper plate; and
a lid threading extending upwardly from the terminal edge of the lateral plate, the lid threading being complementary to the upper end threading of the sleeve wherein the lid is threadably couplable to the sleeve.

11. The scale assembly of claim 1, the lid further comprising:
an upper plate; and
a lateral plate being coupled to and extending downwardly from the upper plate.

12. The scale assembly of claim 11, the lid further comprising a handle being coupled to the upper plate, the handle extending upwardly from the upper plate wherein the handle is configured to facilitate a user in gripping the lid.

13. The scale assembly of claim 1, further comprising a lid gasket being coupled to the lid, the lid gasket comprising a rubber material wherein the lid gasket is configured to seal a junction between the lid and the sleeve when the lid is coupled to the sleeve whereby the lid gasket is configured to inhibit airflow into the container.

14. The scale assembly of claim 1, further comprising a base retainer releasably coupling the base to the scale, the base retainer including:
a base strap being coupled the base;
a first fastening piece being attached to the base strap; and
a second fastening piece being releasably engageable with the first fastening piece, the second fastening piece being coupled to the scale, the second fastening piece being alignable with the first fastening piece when the base is coupled to the scale.

15. A scale assembly comprising:
a scale having a top panel, a bottom panel, and a side panel being coupled to and extending between the top panel and the bottom panel, the bottom panel being planar, the side panel having a threaded upper portion extending downwardly from the top panel, the threaded upper portion being positioned on an outer surface of the scale, the scale further comprising:
a weighing platform being coupled to the top panel, the weighing platform being movably coupled to the top panel wherein a position of the weighing platform is vertically adjustable relative to the top panel;
a processor being positioned inside the scale, the processor being operationally coupled to the weighing platform;
a weight sensor being electrically coupled to the processor wherein the weight sensor is configured to measure a weight of a material being positioned on the weighing platform, the weight sensor being positioned inside of the scale;
a power source being electrically coupled to the processor, the power source comprising a battery, the battery being rechargeable, the power source being positioned inside of the scale;
an access door being coupled to the scale, the access door being positioned on the bottom panel of the scale, the access door being pivotably coupled to the bottom panel and being aligned with the power source wherein the access door is openable to facilitate access to the power source;
a charging port being electrically coupled to the power source wherein the charging port is configured to receive a charging cable for recharging the power source, the charging port being inset into the side panel of the scale, the charging port being exposed within the side panel of the scale;
a display panel being electrically coupled to the processor wherein the display panel is configured to display the weight of the material being measured by the weight sensor, the display panel being coupled to the side panel of the scale;
a control panel being electrically coupled to the processor wherein the processor is configured to actuate the weight sensor when the control panel is manipulated, the processor being configured to tare the weight sensor when the control panel is manipulated, the control panel being coupled to the side panel of the scale, the control panel being positioned adjacent to the display panel, the control panel comprising a button;
a container being releasably couplable to the scale, the container being configured to hold the material while the weight sensor is measuring the weight of the material, the container comprising:
a base being releasably couplable to the scale, the base being positioned over the weighing platform when the base is coupled to the scale wherein the base is configured to inhibit the material from physically contacting the scale while the weight sensor is measuring the weight of the material, the base further comprising:
a peripheral wall having a top edge and a bottom edge, the peripheral wall extending upwardly from the scale when the base is coupled to the scale wherein the bottom edge is positioned adjacent to scale and the top edge is positioned above the scale;
a central wall being coupled to the peripheral wall, the central wall being spaced from the top edge and the bottom edge of the peripheral wall wherein the central wall is positionable on top of the weighing platform when the base is coupled to the scale and wherein the base is configured to hold the material on top of the central wall, the central wall being in physical contact with the weighing platform of the scale wherein the weight sensor is configured to measure the weight of the material being positioned on top of the central wall when the base is coupled to the scale, the central wall comprising a flexible material wherein the weighing platform is configured to exert upward pressure on the central wall when the base is coupled to the scale and wherein the central wall is configured to exert a downward pressure on the weighing platform when the material is positioned on top of the central wall, the weight sensor being configured to measure the weight of the material based on the downward pressure being exerted on the weighing platform by the central wall, the central wall being coextensive with the weighing platform wherein the base is configured to inhibit the material from physically contacting the weighing platform of the scale when the base is coupled to the scale;
a top threading extending downwardly from the top edge of the peripheral wall of the base toward the central wall, the top threading being positioned on an interior surface of the base;
a bottom threading extending upwardly from the bottom edge of the peripheral wall of the base toward the central wall, the bottom threading being positioned on the interior surface of the base, the bottom threading being complementary to the threaded upper portion of the side panel of the scale wherein the base is threadably couplable to the scale;
a base gasket being coupled to the base, the base gasket being positioned on the bottom edge of the peripheral wall, the base gasket being coextensive with the bottom edge of the peripheral wall, the base gasket comprising a rubber material wherein the base gasket is configured to seal a junction between the base and the scale when the base is coupled to the scale whereby the base gasket is configured to inhibit airflow into the container;
a sleeve being releasably couplable to the base, the sleeve having an upper end and a lower end, each of the upper end and the lower end being open wherein the upper end and the lower end are each configured to facilitate placement of the material within the container, the sleeve extending upwardly from the base when the sleeve is coupled to the base wherein the sleeve is configured to increase an amount of the material being held in the container, the sleeve having a height exceeding a height of the base, the sleeve further comprising:
an upper end threading extending downwardly from the upper end, the upper end threading being positioned on an external surface of the sleeve;
a lower end threading extending upwardly from the lower end, the lower end threading being positioned on the external surface of the sleeve, the lower end threading being spaced from the upper end threading, the lower end threading being complementary to the top threading on the peripheral wall of the base wherein the sleeve is threadably couplable to the base;
a resiliently compressible material extending between the upper end and the lower end wherein a height of the sleeve is compressible to facilitate transportation and storage of the container;
a lid being releasably couplable to the sleeve, the lid being positionable over the upper end of the sleeve wherein the lid is configured to inhibit access to the material being held within the container, the lid including:
an upper plate being parallel to the central wall when the sleeve is coupled to the base and when the lid is coupled to the sleeve;
a lateral plate being coupled to and extending downwardly from the upper plate, the lateral plate having a terminal edge being spaced from the upper plate;
a lid threading extending upwardly from the terminal edge of the lateral plate, the lid threading being positioned on an internal face of the lateral plate, the lid threading being complementary to the upper end threading of the sleeve wherein the lid is threadably couplable to the sleeve;
a handle being coupled to the upper plate, the handle extending upwardly from the upper plate wherein the handle is configured to facilitate a user in gripping the lid;
a lid gasket being coupled to the lid, the lid gasket being positioned on the terminal edge of the lateral plate of the lid, the lid gasket being coextensive with the terminal edge of the lateral plate, the lid gasket comprising the rubber material wherein the lid gasket is configured to seal a junction between the lid and the sleeve when the lid is coupled to the sleeve whereby the lid gasket is configured to inhibit airflow into the container;
a lid retainer releasably coupling the lid to the base when the sleeve is compressed, the lid retainer including:
a lid strap being coupled to the upper plate of the lid, the lid strap extending downwardly from the upper plate of the lid;
a first retaining member being attached to the lid strap, the first retaining member being positioned proximate to a free end of the lid strap;
a second retaining member being releasably engageable with the first retaining member, the second retaining member being coupled to an exterior surface of the peripheral wall of the base, the second retaining member being alignable with the first mating member when the sleeve is compressed;
wherein each of the first retaining member and the second retaining member comprise a snap;
a base retainer releasably coupling the base to the scale, the base retainer including:
a base strap being coupled to the peripheral wall of the base, the base strap extending downwardly past the bottom edge of the peripheral wall;
a first fastening piece being attached to the base strap;
a second fastening piece being releasably engageable with the first fastening piece, the second fastening piece being coupled to the side panel of the scale, the second fastening piece being alignable with the first fastening piece when the base is coupled to the scale;
wherein each of the first fastening piece and the second fastening piece comprise a snap;
wherein the outer surface of the scale is coplanar with the exterior surface of the base when the base is coupled to the scale;
wherein the exterior surface of the base is coplanar with the external surface of the sleeve when the sleeve is coupled to the base;
wherein the external surface of the sleeve is coplanar with an external face of the lid when the lid is coupled to the sleeve; and
wherein each of the base and the lid comprises a rigid material being configured to inhibit damage to the material when the material is being held within the container and when the sleeve is compressed, the rigid material comprising plastic.
